(19) United States
(12) Patent Application Publication
(10) Pub. No.: US 2020/0400166 A1
(43) Pub. Date: Dec. 24, 2020

(54) LOAD-ADJUSTING QUICK OIL CYLINDER AND HYDRAULIC LIFTING DEVICE

(71) Applicant: Forcome (Shanghai) Co., Ltd., Shanghai (CN)

(72) Inventor: Weihua CHEN, Shanghai (CN)

(21) Appl. No.: 16/805,705

(22) Filed: Feb. 29, 2020

(30) Foreign Application Priority Data
Jun. 21, 2019 (CN) 201910543574.6

(51) Int. Cl. F15B 15/14; F15B 21/00

(52) U.S. Cl. CPC F15B 15/1428; F15B 21/005

(57) ABSTRACT

A load-adjusting quick cylinder includes: a cylinder base (6); a pump cylinder (9) disposed on a reverse side of the cylinder base (6); a pump core (8) disposed in the pump cylinder (9); and sequentially disposed from inside to outside, an outer piston rod (1), an outer piston rod cylinder (4) and outer casing (3). The outer piston rod (1) includes an inner piston oil chamber (11) that holds a hollow inner piston rod (5); a main oil chamber (13) is provided between the outer casing (3) and the outer piston rod cylinder (4); an outer piston rod oil chamber (12) is provided between the outer piston rod cylinder (4) and the outer piston rod (1); and the inner piston oil chamber (11) and a pump cylinder oil chamber (10) are connected through a circulating oil passage in the cylinder base (6).

The present invention claims priority to Chinese patent application No.: CN 201910543574.6, filed on Jun. 21, 2019, which is which is incorporated by reference for all purposes as if fully set forth herein.

### FIELD OF THE INVENTION

The present invention relates to a load-adjusting quick oil cylinder and a hydraulic lifting device that includes the cylinder.

### BACKGROUND OF THE INVENTION

As the most common application of hydraulic transmission technology, hydraulic lifting devices are used in various engineering fields, large and small. The structure of common hydraulic lifting devices includes lifting cylinders, oil lines and fuel tanks, during use, fuel tank orientation. One end of the cylinder is filled with hydraulic oil to push the piston rod, and the other end of the cylinder returns hydraulic oil to the tank. When the direction of operation is reversed, the process is reversed. Because the oil path is long during the pushing process, the filling speed is limited. The piston stroke period is also long; the lifting is slow; and the lifting efficiency is not high, which affects the work efficiency.

Conventional hydraulic lifting devices use the hydraulic mode of the cylinder to realize the lifting function. Conventional cylinder can only be slowly moved up and down during no-load, it is wasteful of manpower and time. When there is no load, conventional hydraulic lifting devices can't be lifted quickly, and the speed of lifting can't be controlled according to the weight of the load. This greatly reduces the utilization rate of the equipment. There is a need for new hydraulic lifting devices that can adjust speeds depending on the loads on the hydraulic lifting devices.

### SUMMARY OF THE INVENTION

In one embodiment, a load-adjusting quick cylinder includes: a cylinder base (6); a pump cylinder (9) disposed on a reverse side of the cylinder base (6); a pump core (8) disposed in the pump cylinder (9); and sequentially disposed from inside to outside, an outer piston rod (1), an outer piston rod cylinder (4) and outer casing (3). The outer piston rod (1) includes an inner piston oil chamber (11) that holds an inner piston rod (5); a main oil chamber (13) is provided between the outer casing (3) and the outer piston rod cylinder (4); an outer piston rod oil chamber (12) is provided between the outer piston rod cylinder (4) and the outer piston rod (1); and the inner piston oil chamber (11) and a pump cylinder oil chamber (10) are connected through a circulating oil passage in the cylinder base (6). The circulating oil passage includes: an oil suction passage connecting the main oil storage chamber (13) and the cylinder oil chamber (10), a first oil discharge passage connecting the pump cylinder oil chamber (10) and the inner piston oil chamber (11) and adapted for quick ejecting the inner piston rod (5) at light load; a second oil discharge passage connecting the pump cylinder oil chamber (10) and the outer piston rod oil chamber and adapted for slow ejecting the outer piston rod (1) at heavy load; an anti-overload return oil passage connecting the pump cylinder oil chamber (10) and the main oil storage chamber (13); a refilling oil passage connecting the main oil storage chamber (13) and the outer piston rod oil chamber (12); and an unloading returning oil passage connecting the main oil storage chamber (13) with the inner piston oil chamber (11) and the outer piston rod oil chamber (12) and adapted for unloading.

In another embodiment, the cylinder base (6) further includes an oil return slider mechanism (16), a pressure adjusting mechanism (17), a quick adjusting mechanism (18) a slow adjusting mechanism (19) and an oil refilling mechanism (20); the pressure adjusting mechanism (17) is configured to control the opening and closing of the oil suction oil passage, the first oil discharge passage and the second oil discharge passage; the quick adjusting mechanism (18) is configured to control the opening and closing of the anti-overload return oil passage; the slow adjustment mechanism (19) is configured to control the opening and closing of the anti-overload return oil passage; the oil replenishing mechanism (20) is configured to control the opening and closing of the unloading returning oil passage; and the oil return slider mechanism (16) is configured to control the opening and closing of the anti-overload return oil passage.

In another embodiment, the pressure adjusting mechanism (17) is disposed in a first vertically-opened four-stage boss-shaped hole with decreasing diameter that includes, from bottom to top, a third plugging steel ball (172), a second plugging steel ball (171), a second spring (173), a first limit steel ball (174), and a first adjustment screw (175); a fourth stage hole connects with the main oil storage chamber (13) through a main oil storage chamber oil outlet (22) and connects sequentially with a first middle flow passage (34) and the pump cylinder oil chamber (10) through a pump cylinder oil chamber main oil outlet (23); a second stage hole connects sequentially with the inner piston rod oil chamber (11) through the second middle flow passage (30) and an inner piston rod oil chamber oil hole (21); the third plugging steel ball (172) moves up and down in a third stage hole to control the opening and closing of the third stage hole and the main oil-storing oil outlet (22); the second plugging steel ball (171) and the second spring (173) are disposed in the second stage hole; the first limit steel ball (174) is disposed in a first stage hole; the first adjusting screw (175) controls an initial position of the third plugging steel ball (172); the second spring (173) is connected to the third plugging steel ball (172) and the first limit steel ball (174); the third plugging steel ball (172) moves up and down in the second stage hole to control the opening and closing between the pump cylinder oil chamber main oil outlet (23) and the second middle flow passage (30).

In another embodiment, the quick adjusting mechanism (18) is disposed in a second vertically-opened four-stage boss-shaped hole with decreasing diameter that includes, from bottom to top, a fifth plugging steel ball (184), a fourth plugging steel ball (183), a third spring (182), a second adjusting screw (185), and a first plugging screw (181); the outer piston rod oil chamber (12) connects with an outer piston rod oil chamber oil return hole (25) to control the opening and closing of the fifth plugging steel ball (184); and the fourth plugging steel ball (183), the third spring (182) and the second adjusting screw (185) control the opening and closing between the second middle flow path (30) and the outer piston rod oil chamber (12).

In another embodiment, the slow adjustment mechanism (19) is disposed in a first vertically-opened three-stage boss-shaped hole with decreasing diameter that includes, from bottom to top, a sixth plugging steel ball (195), a second speed limit block (194), a fourth spring (193), a third adjustment screw (192), and a second plugging screw (191); a first anti-overload oil return hole (26) and the first middle flow passage (34) connect with the pump cylinder oil chamber (10); and the second speed limiting block (194), the fourth spring (193), and the third adjusting screw (192) are connected with the main oil chamber (13) through a second anti-overload oil return hole (27).

In another embodiment, the oil-replenishing mechanism (20) is disposed in a second vertically-opened three-stage boss-shaped hole with decreasing diameter that includes a third plugging screw (201), an eighth plugging steel ball, and a seventh plugging steel ball (202); an oil refilling hole (29) connects with the main oil storage chamber (13); and an outer piston rod oil chamber oil outlet (24) connects with the outer piston rod oil chamber (12).

In another embodiment, the oil return slider mechanism (16) is disposed in a mounting hole in the cylinder base (6) and includes an oil return slider main body (161), a pressure relief oil return button (162) disposed on the oil return slider main body (161), and, from bottom to top disposed in an internal passage of oil return slider main body (161), a first speed limit block (164), a first spring (163) a first plugging steel ball (165) and a transmission spring (167); the internal passage is a three-stage boss-shaped hole with decreasing diameter; an oil return hole (28) connects with the main oil storage chamber (13); and the transmission spring (167) connects with the pressure relief oil return button (162) and the first plugging steel ball (165) at both ends.

In another embodiment, the first speed-limiting block (164) is a speed-limiting block in which arcuate passages are provided on left and right sides thereof.

In another embodiment, a hydraulic lifting device includes the load-adjusting quick cylinder of the present invention.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is an overall assembly diagram of a load-adjusting quick oil cylinder.

FIG. 2 is a schematic view of the A-A section of FIG. 1.

FIG. 3 is a schematic view of the B-B section of FIG. 1.

FIG. 4 is a schematic view of the sealing layer of the load-adjusting quick oil cylinder.

FIG. 5 is a top view of the load-adjusting quick oil cylinder.

FIG. 6 is an enlarged view showing the structure of an oil return slider mechanism.

FIG. 7 is a schematic view of a speed limit block.

FIG. 8 is a hydraulic lifting device that includes the load-adjusting quick oil cylinder.

In the figures: 1, outer piston rod; 2, top hat, 3, outer casing; 4, outer piston rod cylinder; 5, inner piston rod; 6, cylinder base; 7, cylinder mounting plate; 8, pump core; 9, pump cylinder; 10, pump cylinder oil chamber; 11, inner piston rod oil chamber; 12, outer piston rod oil chamber; 13, main oil storage chamber; 14, inner piston rod gasket; 15, sealing ring; 16, oil return slider mechanism; 17, pressure adjusting mechanism; 18, quick adjusting mechanism; 19, slow adjustment mechanism; 20, oil refilling mechanism; 21, inner piston rod oil chamber oil hole; 22, main oil storage chamber oil outlet; 23, pump oil chamber main oil outlet; 24, outer piston rod oil chamber oil outlet; 25, outer piston rod oil chamber oil return hole; 26, first anti-overload oil return hole; 27, second anti-overload oil return hole; 28, oil return hole; 29, oil refilling hole; 30, second middle flow passage; 31, main oil storage chamber sealing layer; 32, outer piston rod oil chamber sealing layer; 33, inner piston rod oil chamber sealing layer; 34, first middle flow passage; 161, oil return slider main body; 162, pressure release oil return button; 163, first spring; 164, first speed limit block; 165, first plugging steel ball; 166, pressure relief oil return chamber; 167, transmission spring 171; second plugging steel ball; 172, third plugging steel ball; 173, the second spring; 174, first limit steel ball; 175, first adjustment screw; 181, first plugging screw; 182, third spring; 183, fourth blocking steel ball; 184, fifth plugging steel ball; 185, second adjusting screw; 191, second blocking screw; 192, third adjusting screw; 193, fourth spring; 194, second speed limit block; 195, sixth block steel ball; 201, third plugging screw; 202, seventh block steel ball; 40, base; 41, X-type telescopic frame; 42, handle; 43, stage; 44, foot pedal; 45, connecting rod; 46, operating handle.

### DETAILED DESCRIPTION OF THE ILLUSTRATED EMBODIMENTS

Reference will now be made in detail to embodiments of the present invention, example of which is illustrated in the accompanying drawings.

### Examples

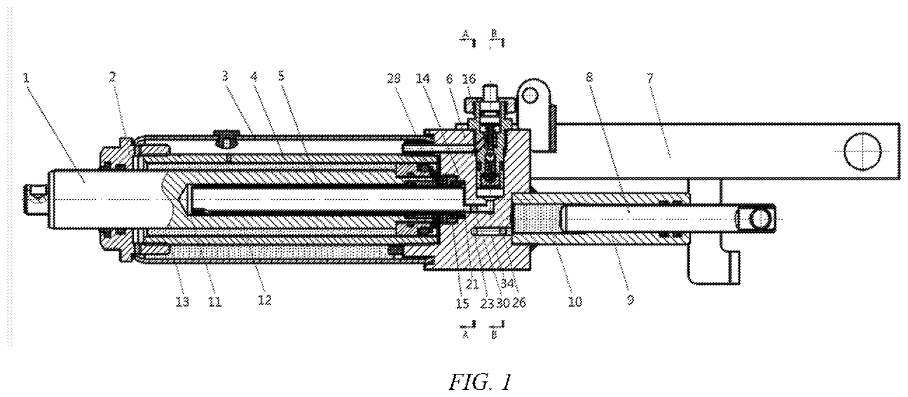

As shown in FIG. 1, the present invention provides a load-adjusting quick cylinder that includes a cylinder base 6; a pump cylinder 9 disposed on the reverse side of the cylinder base 6; a pump core 8 disposed in the pump cylinder 9; and sequentially disposed from inside to outside, an outer piston rod 1, an outer piston rod cylinder 4 and an outer sleeve 3. The outer piston rod 1 includes an inner piston oil chamber 11 that holds an inner piston rod 5; a main oil chamber 13 is provided between the outer casing 3 and the outer piston rod cylinder 4; an outer piston rod oil chamber 12 is provided between the outer piston rod cylinder 4 and the outer piston rod 1; and the inner piston oil chamber 11 and a pump cylinder oil chamber 10 are connected through a circulating oil passage in the cylinder base 6.

The cylinder base 6 further includes an oil return slider mechanism 16, a pressure adjusting mechanism 17, a quick adjusting mechanism 18 a slow adjusting mechanism 19 and an oil refilling mechanism 20. The pressure adjusting mechanism 17 is configured to control the opening and closing of the oil suction oil passage, the first oil discharge passage and the second oil discharge passage. The quick adjusting mechanism 18 is configured to control the opening and closing of the anti-overload return oil passage. The slow adjustment mechanism 19 is configured to control the opening and closing of the anti-overload return oil passage. The oil replenishing mechanism 20 is configured to control the opening and closing of the unloading returning oil passage. The oil return slider mechanism 16 is configured to control the opening and closing of the anti-overload return oil passage.

Each circulating oil passage is controlled by the oil return slider rod mechanism 16, the pressure adjusting mechanism 17, the quick adjusting mechanism 18, the slow adjusting mechanism 19, and the oil refilling mechanism 20, respectively, thereby achieving fast jacking, slow jacking, pressure relief oil returning, anti-overload oil returning, and anti-vacuum fil refilling. The details of the mechanisms are as follows.

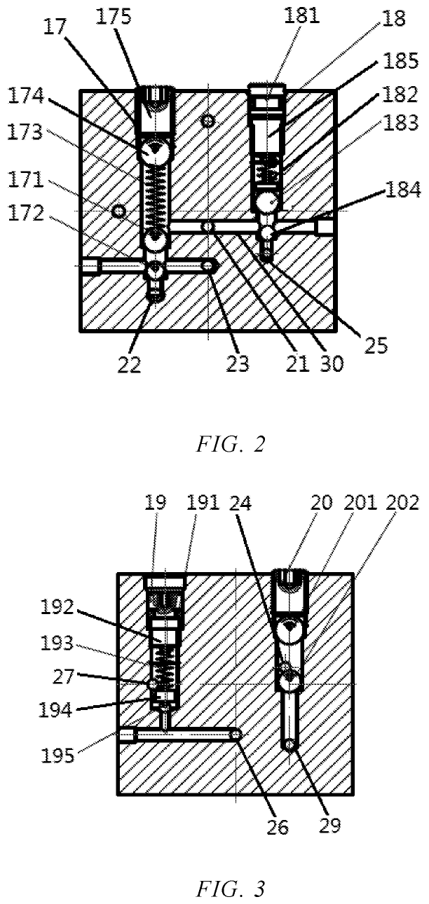

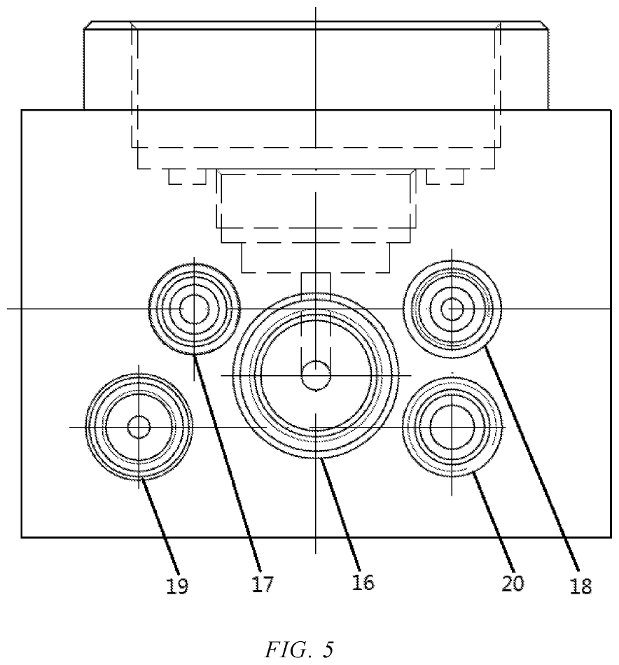

As shown in FIGS. 2 and 5, the pressure adjusting mechanism 17 is disposed in a first vertically-opened four-stage boss-shaped hole with decreasing diameter that includes, from bottom to top, a third plugging steel ball 172, a second plugging steel ball 171, a second spring 173, a first limit steel ball 174, and a first adjustment screw 175. A fourth stage hole connects with the main oil storage chamber 13 through a main oil storage chamber oil outlet 22 and connects sequentially with a first middle flow passage 34 and the pump cylinder oil chamber 10 through a pump cylinder oil chamber main oil outlet 23. A second stage hole connects sequentially with the inner piston rod oil chamber 11 through the second middle flow passage 30 and an inner piston rod oil chamber oil hole 21.

The third plugging steel ball 172 moves up and down in a third stage hole to control the opening and closing of the third stage hole and the main oil-storing oil outlet 22. The second plugging steel ball 171 and the second spring 173 are disposed in the second stage hole. The first limit steel ball 174 is disposed in a first stage hole; the first adjusting screw 175 controls an initial position of the third plugging steel ball 172. The second spring 173 is connected to the third plugging steel ball 172 and the first limit steel ball 174. The third plugging steel ball 172 moves up and down in the second stage hole to control the opening and closing between the pump cylinder oil chamber main oil outlet 23 and the second middle flow passage 30.

As shown in FIGS. 3 and 5, the slow adjustment mechanism 19 is disposed in a first vertically-opened three-stage boss-shaped hole with decreasing diameter that includes, from bottom to top, a sixth plugging steel ball 195, a second speed limit block 194, a fourth spring 193, a third adjustment screw 192, and a second plugging screw 191. A first anti-overload oil return hole (26) and the first middle flow passage 34 connect with the pump cylinder oil chamber 10 The second speed limiting block 194, the fourth spring 193, and the third adjusting screw 192 are connected with the main oil chamber 13 through a second anti-overload oil return hole 27.

The oil-replenishing mechanism 20 is disposed in a second vertically-opened three-stage boss-shaped hole with decreasing diameter that includes a third plugging screw 201, an eighth plugging steel ball, and a seventh plugging steel ball 202. An oil refilling hole 29 connects with the main oil storage chamber 13. An outer piston rod oil chamber oil outlet 24 connects with the outer piston rod oil chamber 12.

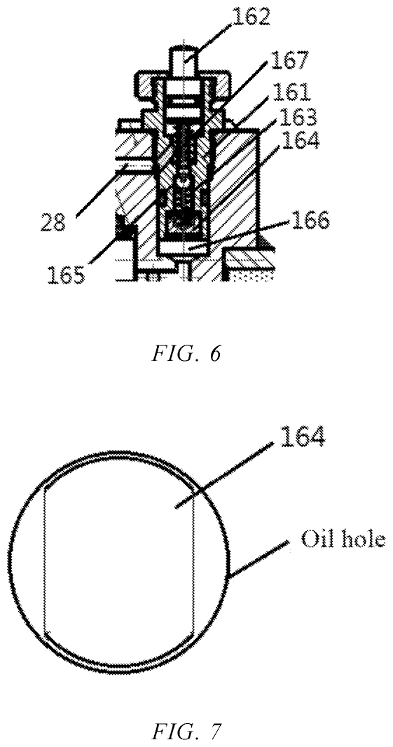

As shown in FIGS. 5 and 6, the oil return slider mechanism 16 is disposed in a mounting hole in the cylinder base 6 and includes an oil return slider main body 161, a pressure relief oil return button 162 disposed on the oil return slider main body 161, and, from bottom to top disposed in an internal passage of oil return slider main body 161, a first speed limit block 164, a first spring 163 a first plugging steel ball 165 and a transmission spring 167. The internal passage is a three-stage boss-shaped hole with decreasing diameter. An oil return hole 28 connects with the main oil storage chamber 13. The transmission spring 167 connects with the pressure relief oil return button 162 and the first plugging steel ball 165 at both ends.

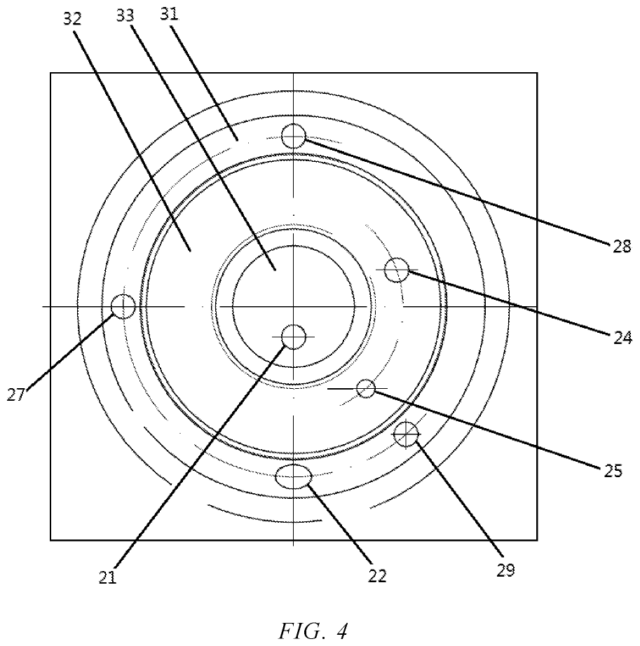

As shown in FIG. 4, the front surface of the cylinder base 6 includes three sealing layers, from outside to inside, main oil storage chamber sealing layer 31, outer piston rod oil chamber sealing layer 32, and inner piston rod oil chamber sealing layer 33. The connections to connection holes are as follows:

In the main oil storage chamber sealing layer 31, main oil storage chamber oil outlet 22, second anti-overload oil return hole 27, oil return hole 28, and oil refilling hole 2 are arranged in a circumferential direction and connect to the main oil storage chamber 13.

In the outer piston rod oil chamber sealing layer 32, outer piston rod oil chamber oil outlet 24 and outer piston rod oil chamber oil return hole 25 are arranged in a circumferential direction and connect to the outer piston rod oil chamber 12.

In the inner piston rod oil chamber sealing layer 33, an inner piston rod oil chamber oil hole 21 connects to the inner piston rod oil chamber 11.

As shown in FIG. 7, the first speed limiting block 164 and the second speed limiting block 194 are speed limiting blocks provided with arcuate passages on both left and right sides, which are installed in corresponding restricting holes. When facing a large oil pressure, the flowing oil body is slowed by the arcuate passages on the left and right sides during the impact to prevent damage caused by excessive pressure.

The specific working principle of each circulating oil passage of the quick oil cylinder is as follows:

The cycle oil circuit mainly includes:

1. An oil absorption oil passage connecting the main oil storage chamber 13 and the pump cylinder oil chamber 10

When the piston rod is not ejected, the oil stored in the main oil chamber 13 first needs to be sucked into the pump cylinder oil chamber 10. As the pump core 8 moves outward, the oil in the main oil chamber 13 passes through the main oil chamber 13. The oil passes from the main oil chamber 13 through the main oil storage chamber oil outlet 22, lifting up the third plugging steel ball 172. The oil then passes through the pump oil chamber main oil outlet hole 23 and the first middle flow channel 34, and enters the pump cylinder oil chamber 10. It should be noted that the first adjusting screw 175 can set the tightening degree according to the process requirement, and the oil pressure required for lifting the second blocking steel ball 171 is controlled. In the oil sucking process, the third blocking steel ball 172 is upward. After jacking, the pressure of the second plugging steel ball 171 and the pressure of the second spring 173 ensure that the second plugging steel ball 171 is not jacked up, so that the oil cannot enter the piston rod oil chamber.

2. An inner piston rod oil passage connecting the pump cylinder oil chamber 10 and the inner piston rod oil chamber 11 for light load fast ejection

After the oil suction is completed, the no-load fast ejection is performed. The pump core 8 is subjected to a thrust, so that the oil in the pump cylinder oil chamber 10 passes through the first middle flow passage 34 and the pump oil chamber main oil outlet hole 23, due to the oil pressure. The second blocking steel ball 171 is lifted upwards, so that the oil enters the intermediate flow hole 30 and enters the hollow inner piston rod 5 from the oil hole of the inner piston rod oil chamber. At this time, the oil enters the inner piston rod oil chamber because the inner piston rod 5 has a small area. The outer piston rod 1 can be quickly ejected, thereby achieving the purpose of no-load fast ejection. After the second plugging steel ball 171 is lifted up, the fifth plugging steel ball blocks the outer piston rod oil chamber oil return hole 25. The second adjustment screw 185 can be used to adjust the pressure so that the pressure on the fourth plugging steel ball 183 is greater than the pressure on the second plugging steel ball 171 and the fourth plugging steel ball 183 cannot be lifted up. Thus, the fourth plugging steel ball 183 blocks the outer piston rod oil chamber oil outlet 24. The oil does not enter the outer piston rod oil chamber (the oil is replenished here to prevent the outer piston rod oil chamber from being vacuumed out). In the present application, the pressure on the second plugging steel ball 171 and the fourth plugging steel ball 183 work together to achieve quick lifting when there is no load.

3. An oil passage connecting the pump cylinder oil chamber 10 and the outer piston rod oil chamber 12 for heavy load slow ejecting;

After the oil sucking is completed, the heavy load is slowly ejected. The pump core 8 is subjected to a thrust, so that the oil in the pump cylinder oil chamber 10 passes through the first middle flow passage 34 and the pump oil chamber main oil outlet hole 23. Because the oil pressure is high, the second plugging steel ball 171 is lifted upward. With the heavy load, the oil in the oil chamber 1 of the pump cylinder is subjected to a pressure greater than the pressure with no-load. The pressure lifts up the fourth plugging steel ball 183, and the outer piston rod oil chamber oil outlet 24 is opened. The oil enters the outer piston rod oil chamber 12 through the outer piston rod oil chamber oil outlet 24, and a small portion of the oil enters the inner piston rod oil chamber 11. The outer piston rod 1 can be slowly ejected, which is suitable for smooth and slow lifting with heavy load.

4. A refilling oil passage connecting the main oil storage chamber 13 and the outer piston rod oil chamber 12

The refilling oil passage is only turned on during quick ejection with no load. The purpose is to prevent the outer piston rod oil chamber from being unable to eject due to the vacuum formed. At this time, the oil passes from the main oil storage chamber 13 through the oil refilling hole 29, lifts up the seventh plugging steel ball, and connects the oil refilling hole 29 with the outer piston rod oil chamber oil outlet hole 24, thereby refilling the oil.

5. An anti-overload return oil passage connecting the pump cylinder oil chamber 10 and the main oil storage chamber 13

When the load is overweight, the oil pressure exceeds the set limit of the fourth plugging steel ball 183. To prevent damage caused by excessive oil pressure, it is necessary to return the overpressure oil to the main oil storage chamber 13. During the heavy load slow ejection process, the oil in the pump cylinder oil chamber 10 lifts up the second plugging steel ball 171 and the fourth plugging steel ball 183. Because the pressure is higher than the preset overload pressure of the sixth block steel ball 195, the oil in the pump cylinder oil chamber 10 passes through the first anti-overload oil return hole 26 to lift up the sixth block steel ball 195, thereby opening the anti-overload return oil passage. Under the restriction of the second speed limiting block 194, the oil passes through the second anti-overload oil return hole 27 and returns to the main oil storage chamber 13 to effectively prevent damage caused by overload.

6. An unloading returning oil passage connecting the main oil storage chamber 13 and outer piston rod oil chamber 11

When an unloading reset is required, a pressure relief oil return button 162 can be pressed. A transmission spring 167 pushes the first plugging steel ball 165 to open the unloading returning oil passage. The oil in the outer piston rod oil chamber 11 and the outer piston rod oil chamber 12 returns to pressure relief oil chamber 166 under the pressure.

Under the action of the first speed limiting block 164, the oil slowly passes through an internal passage of the oil return slider main body 161 and the oil return hole 28 to return to the main oil storage chamber 13, thereby achieving a slow and steady reset.

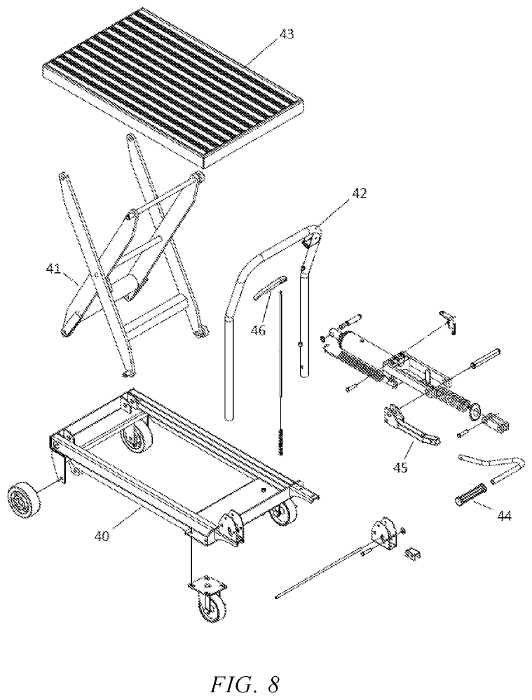

As shown in FIG. 8, the figure shows an application of the quick cylinder of the present invention. A hydraulic lifting device includes a base 40, a quick oil cylinder, an X-shaped telescopic frame 41, a handle 42 and a stage 43 disposed on the X-shaped telescopic frame 41. The quick oil cylinder is fixed to the base 40 by a cylinder mounting plate 7. The head of the outer piston rod 1 is drivingly connected with the X-type telescopic frame 41. The base is provided with a foot pedal 44. The food pedal 44 is connected to the pump core 8 via a connecting rod 45. The handle 42 is provided with an operating handle 46. The operating handle 46 is connected to the pressure relief oil button 162 through a connecting lever, and a reset spring is provided on the outside of the pump core 8 for resetting. With no load, the food pedal can be pressed to push the pump core 8 inwardly, to press the oil in the pump cylinder oil chamber 10, and to push the outer piston rod 1 out. The X-type telescopic frame is then extended to lift the stage. The hydraulic lifting device effectively distinguishes and sets the movement speed under no-load (light load), heavy load and overload, respectively. It realizes the control of the lifting speed according to the light weight of the load, increases the utilization rate of the equipment, and is safe and easy to operate.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A load-adjusting quick cylinder comprising:
a cylinder base (6); a pump cylinder (9) disposed on a reverse side of the cylinder base (6); a pump core (8) disposed in the pump cylinder (9); and sequentially disposed from inside to outside, an outer piston rod (1), an outer piston rod cylinder (4) and outer casing (3),
wherein the outer piston rod (1) includes an inner piston oil chamber (11) that holds an inner piston rod (5); a main oil chamber (13) is provided between the outer casing (3) and the outer piston rod cylinder (4); an outer piston rod oil chamber (12) is provided between the outer piston rod cylinder (4) and the outer piston rod (1); and the inner piston oil chamber (11) and a pump cylinder oil chamber (10) are connected through a circulating oil passage in the cylinder base (6).

2. The load-adjusting quick cylinder according to claim 1, wherein the circulating oil passage comprises:
an oil suction passage connecting the main oil storage chamber (13) and the cylinder oil chamber (10),
a first oil discharge passage connecting the pump cylinder oil chamber (10) and the inner piston oil chamber (11) and adapted for quick ejecting the inner piston rod (5) at light load;
a second oil discharge passage connecting the pump cylinder oil chamber (10) and the outer piston rod oil chamber and adapted for slow ejecting the outer piston rod (1) at heavy load;
an anti-overload return oil passage connecting the pump cylinder oil chamber (10) and the main oil storage chamber (13);
a refilling oil passage connecting the main oil storage chamber (13) and the outer piston rod oil chamber (12); and
an unloading returning oil passage connecting the main oil storage chamber (13) with the inner piston oil chamber (11) and the outer piston rod oil chamber (12) and adapted for unloading.

3. The load-adjusting quick cylinder according to claim 2, wherein:
the cylinder base (6) further comprises an oil return slider mechanism (16), a pressure adjusting mechanism (17), a quick adjusting mechanism (18) a slow adjusting mechanism (19) and an oil refilling mechanism (20);
the pressure adjusting mechanism (17) is configured to control the opening and closing of the oil suction oil passage, the first oil discharge passage and the second oil discharge passage;
the quick adjusting mechanism (18) is configured to control the opening and closing of the anti-overload return oil passage;
the slow adjustment mechanism (19) is configured to control the opening and closing of the anti-overload return oil passage;
the oil replenishing mechanism (20) is configured to control the opening and closing of the unloading returning oil passage; and
the oil return slider mechanism (16) is configured to control the opening and closing of the anti-overload return oil passage.

4. The load-adjusting quick cylinder according to claim 3, wherein:
the pressure adjusting mechanism (17) is disposed in a first vertically-opened four-stage boss-shaped hole with decreasing diameter that includes, from bottom to top, a third plugging steel ball (172), a second plugging steel ball (171), a second spring (173), a first limit steel ball (174), and a first adjustment screw (175); a fourth stage hole connects with the main oil storage chamber (13) through a main oil storage chamber oil outlet (22) and connects sequentially with a first middle flow passage (34) and the pump cylinder oil chamber (10) through a pump cylinder oil chamber main oil outlet (23); a second stage hole connects sequentially with the inner piston rod oil chamber (11) through the second middle flow passage (30) and an inner piston rod oil chamber oil hole (21);
the third plugging steel ball (172) moves up and down in a third stage hole to control the opening and closing of the third stage hole and the main oil-storing oil outlet (22); the second plugging steel ball (171) and the second spring (173) are disposed in the second stage hole; the first limit steel ball (174) is disposed in a first stage hole; the first adjusting screw (175) controls an initial position of the third plugging steel ball (172); the second spring (173) is connected to the third plugging steel ball (172) and the first limit steel ball (174); the third plugging steel ball (172) moves up and down in the second stage hole to control the opening and closing between the pump cylinder oil chamber main oil outlet (23) and the second middle flow passage (30).

5. The load-adjusting quick cylinder according to claim 3, wherein:
the quick adjusting mechanism (18) is disposed in a second vertically-opened four-stage boss-shaped hole with decreasing diameter that includes, from bottom to top, a fifth plugging steel ball (184), a fourth plugging steel ball (183), a third spring (182), a second adjusting screw (185), and a first plugging screw (181); the outer piston rod oil chamber (12) connects with an outer piston rod oil chamber oil return hole (25) to control the opening and closing of the fifth plugging steel ball (184); and the fourth plugging steel ball (183), the third spring (182) and the second adjusting screw (185) control the opening and closing between the second middle flow path (30) and the outer piston rod oil chamber (12).

6. The load-adjusting quick cylinder according to claim 3, wherein:
the slow adjustment mechanism (19) is disposed in a first vertically-opened three-stage boss-shaped hole with decreasing diameter that includes, from bottom to top, a sixth plugging steel ball (195), a second speed limit block (194), a fourth spring (193), a third adjustment screw (192), and a second plugging screw (191); a first anti-overload oil return hole (26) and the first middle flow passage (34) connect with the pump cylinder oil chamber (10); and the second speed limiting block (194), the fourth spring (193), and the third adjusting screw (192) are connected with the main oil chamber (13) through a second anti-overload oil return hole (27).

7. The load-adjusting quick cylinder according to claim 3, wherein:
the oil-replenishing mechanism (20) is disposed in a second vertically-opened three-stage boss-shaped hole with decreasing diameter that includes a third plugging screw (201), an eighth plugging steel ball, and a seventh plugging steel ball (202); an oil refilling hole (29) connects with the main oil storage chamber (13); and an outer piston rod oil chamber oil outlet (24) connects with the outer piston rod oil chamber (12).

8. The load-adjusting quick cylinder according to claim 3, wherein:
the oil return slider mechanism (16) is disposed in a mounting hole in the cylinder base (6) and includes an oil return slider main body (161), a pressure relief oil return button (162) disposed on the oil return slider main body (161), and, from bottom to top disposed in an internal passage of oil return slider main body (161), a first speed limit block (164), a first spring (163) a first plugging steel ball (165) and a transmission spring (167); the internal passage is a three-stage boss-shaped hole with decreasing diameter; an oil return hole (28) connects with the main oil storage chamber (13); and the transmission spring (167) connects with the pressure relief oil return button (162) and the first plugging steel ball (165) at both ends.

9. The load-adjusting quick cylinder according to claim 8, wherein the first speed-limiting block (164) is a speed-limiting block in which arcuate passages are provided on left and right sides thereof.

10. A hydraulic lifting device comprising the load-adjusting quick cylinder according to claim 1.
